(19) United States
(12) Patent Application Publication
(10) Pub. No.: US 2013/0086478 A1
(43) Pub. Date: Apr. 4, 2013

(54) SYSTEMS AND METHODS FOR MULTIMEDIA EDITING

(71) Applicants: Lon Gibby, Colbert, WA (US); Fletcher McBeth, San Marcos, CA (US); Beau Robert Allen Garner, Spokane Valley, WA (US)

(72) Inventors: Lon Gibby, Colbert, WA (US); Fletcher McBeth, San Marcos, CA (US); Beau Robert Allen Garner, Spokane Valley, WA (US)

(73) Assignee: GIBBY MEDIA GROUP INC., SPOKANE, WA (US)

(21) Appl. No.: 13/702,690

(22) PCT Filed: Jun. 8, 2011
(86) PCT No.: PCT/US2011/039662

§ 371 Date: Dec. 7, 2012

Related U.S. Application Data
(60) Provisional application No. 61/352,649, filed on Jun. 8, 2010.
(60) Provisional application No. 61/352,657, filed on Jun. 8, 2010.

(51) Int. Cl. H04L 29/08

(52) U.S. Cl. CPC H04L 29/08081
USPC 715/738

(57) ABSTRACT

Systems and methods for storing, editing and producing multimedia productions on a server. A system includes one or more servers containing a storage device and a plurality of tools allowing users to store and edit multimedia productions using a browser on a client. Additional system tools render the edited multimedia data into a multimedia production that is distributed using a real time streaming tool. Multimedia productions are created through the method of uploading and storing multi-media data onto a content library, editing the stored multimedia data, rendering the edited multimedia data into a viewable multi-media production and providing an audience with real time streaming of the multimedia production over a network.

### CROSS REFERENCE TO RELATED APPLICATIONS

This application claims the benefit of U.S. Provisional Application Ser. No. 61/352,657 filed Jun. 8, 2010 and U.S. Provisional Application Ser. No. 61/352,649 filed Jun. 8, 2010 and the entire contents therein are hereby incorporated by reference.

### FIELD OF THE INVENTION

Embodiments disclosed herein relate generally to multimedia and more specifically to systems and methods for storing, editing and producing multimedia productions.

### BACKGROUND

With the number of devices capable of producing video and audio content growing at an extremely rapid rate, digital video and audio products and services have grown in popularity. With the growing popularity of digital audio and video products, there has been a resulting demand for multimedia editing products and an outlet for sharing the edited multimedia projects with the audience. In recent years, a number of websites have come into existence that allows users to publish and share multimedia productions online. Typically, such websites do not support editing of multimedia content.

Existing multimedia editing products include independent specially-configured editing machines and multimedia editing software that can be installed on devices such as personal computers. These products can often be difficult for untrained professionals to operate and their use can be very time consuming. In addition, in the area of multimedia editing, large volumes of data need to be stored, accessed and manipulated. As networks have grown more popular, users have access to multimedia files from the web and are no longer reliant of self produced multimedia content. However, since multimedia files usually have very large sizes, they demand significant bandwidth for network transmission. As a result, it often takes a long time for users to perform downloads of the multimedia content files they wish to edit. Finally, none of the multimedia editing products have the ability to support collaborative multimedia production.

There exists a need for a multimedia editing tool that does not require a user to have editing products on their own computers, that requires limited to no storage of multimedia content by the users, and that allows users to collaboratively edit multimedia content.

The present disclosure addresses the forgoing problems.

### SUMMARY OF THE DISCLOSURE

Embodiments of the disclosure described herein relate to systems and methods for storing, editing and producing multimedia productions on a server. The systems and methods are capable of allowing users to collaborate in the creation of multimedia productions. With server based multimedia editing, any device capable of running a browser can be used to perform multimedia editing because no local storage or significant processing capability is required.

In one general aspect, some example embodiments described by the present disclosure are directed to systems and methods for storing, editing and producing multimedia productions. According to theses various examples, the system has a server. The server has a storage device for storing multimedia data within a content library. The server also has various tools including a multimedia editing tool allowing a user using a browser on a client to edit the stored multimedia data, a rendering tool allowing a user using a browser capable client to create a viewable multimedia production from the edited multimedia data and a real time streaming tool for distributing the viewable multimedia production.

In another embodiment the server can be one of a plurality of servers each of which is capable of communicating with the storage device. In another embodiment, the plurality of servers utilize a content delivery network (CDN) of edge servers to copy the content library to server located physically closer to the user. In yet another embodiment, the storage device is one of a plurality of storage devices each of which is capable of communicating with the server.

In another embodiment, the system for storing, editing and producing multimedia productions represent the multimedia data stored within the content library by displaying thumbnail pictures of the multimedia data.

In yet another embodiment, the content library of the system for storing, editing and producing multimedia productions contains a search function.

In yet another embodiment, the multimedia data is made up of a plurality of clips and the multimedia editing tool is configured to allow a number of editing actions including: combining one or more clips, cropping one or more clips, inserting one or more clips, overlaying one or more clips, removing a portion of one or more clips, adding a transitional effect to one or more clips, inserting text in one or more clips, and inserting sound in one or more clips.

In yet another embodiment, the multimedia editing tool allows for multiple users to work collaboratively to edit the stored multimedia data. In yet another embodiment, the rendering tool converts the edited multimedia production into a format selected by the user. A set of predetermined values are used during the conversion based on the user's selected format.

Embodiments disclosed herein also include methods for providing multimedia storing, editing and production capabilities to a user on a client by uploading and storing multimedia data on a content library. The content library has a server and various tools capable of communicating with the user's client. The user can edit multimedia data stored within the content library and a rendering tool converts the edited multimedia data into a viewable multimedia production. Finally, real time streaming of the viewable multimedia production can be made available via a network.

Further to the foregoing method, the server is one of a plurality of servers each of which is capable of communicating with the user's client. Further still, the plurality of servers utilize a content delivery network (CDN) of edge servers to copy the content library to server located physically closer to the user. Further still, the multimedia data includes a plurality of clips and the step of editing can include combining one or more clips, cropping one or more clips, inserting one or more clips, overlaying one or more clips, removing a portion of one or more clips, adding a transitional effect to one or more clips, inserting text in one or more clips, and inserting sound in one or more clips.

In yet another embodiment, the foregoing methods includes the step of searching the content library. Further to the foregoing methods, the multimedia editing tool allows for multiple users to work collaboratively to edit the stored multimedia data. In yet another embodiment, the edited multimedia production when rendered is converted into a format selected by the user. A set of predetermined values are used during the conversion based upon the user's selected format.

### BRIEF DESCRIPTION OF THE FIGURES

The novel features of the described embodiments are set forth with particularity in the appended claims. The described example embodiments, however, both as to organization and methods of operation, may be best understood by reference to the following description, taken in conjunction with the accompanying drawings in which:

FIG. 1 depicts a diagram of a system for multimedia storing, editing and production according to an example embodiment.

FIG. 2 depicts a block diagram for a system for multimedia storing, editing and production of FIG. 1.

FIG. 3 depicts a block diagram of content flow through an embodiment of the system.

FIG. 4 is a screen shot of an exemplar user web page home screen with login screen and navigation bar, provided by the system of FIG. 1.

FIG. 5 is a screen shot of an exemplar user web page providing the content library showing multimedia data uploaded to the system storage device, provided by the system of FIG. 1

FIG. 6 is a screen shot of an exemplar user web page providing the storage device upload screen for uploading new multimedia data to the content library, provided by the system of FIG. 1.

FIG. 7 is a screen shot of an exemplar user web page providing the editing tool showing four multimedia data files in the editing process, provided by the system of FIG. 1.

FIG. 8 is a screen shot of an exemplar user web page providing the editing tool showing the cropping of a multimedia data file, provided by the system of FIG. 1.

FIG. 9 is a screen shot of an exemplar user web page providing the editing tool showing the combining a plurality of multimedia data files, provided by the system of FIG. 1.

FIG. 10 is a screen shot of an exemplar user web page providing the rendering tool showing the rendering of a multimedia production made up of a plurality of multimedia data files, provided by the system of FIG. 1

FIG. 11 is a screen shot of an exemplar user web page home screen with login screen and navigation bar, provided by the system of FIG. 1.

FIG. 12 is a screen shot of an exemplar user web page providing the content library showing multimedia data uploaded to the system storage device, provided by the system of FIG. 1.

FIG. 12a is a screen shot of an embodiment of the screen of a user when the add user icon is selected.

FIG. 12b is a screen shot of an embodiment of the screen of a user when there are shared projects.

FIGS. 13a and 13b are screen shots of an embodiment of an editing screen constructed in accordance with the invention.

FIG. 14 is a screen shot of the editing screen of FIG. 13a being used to edit video content.

### DETAILED DESCRIPTION

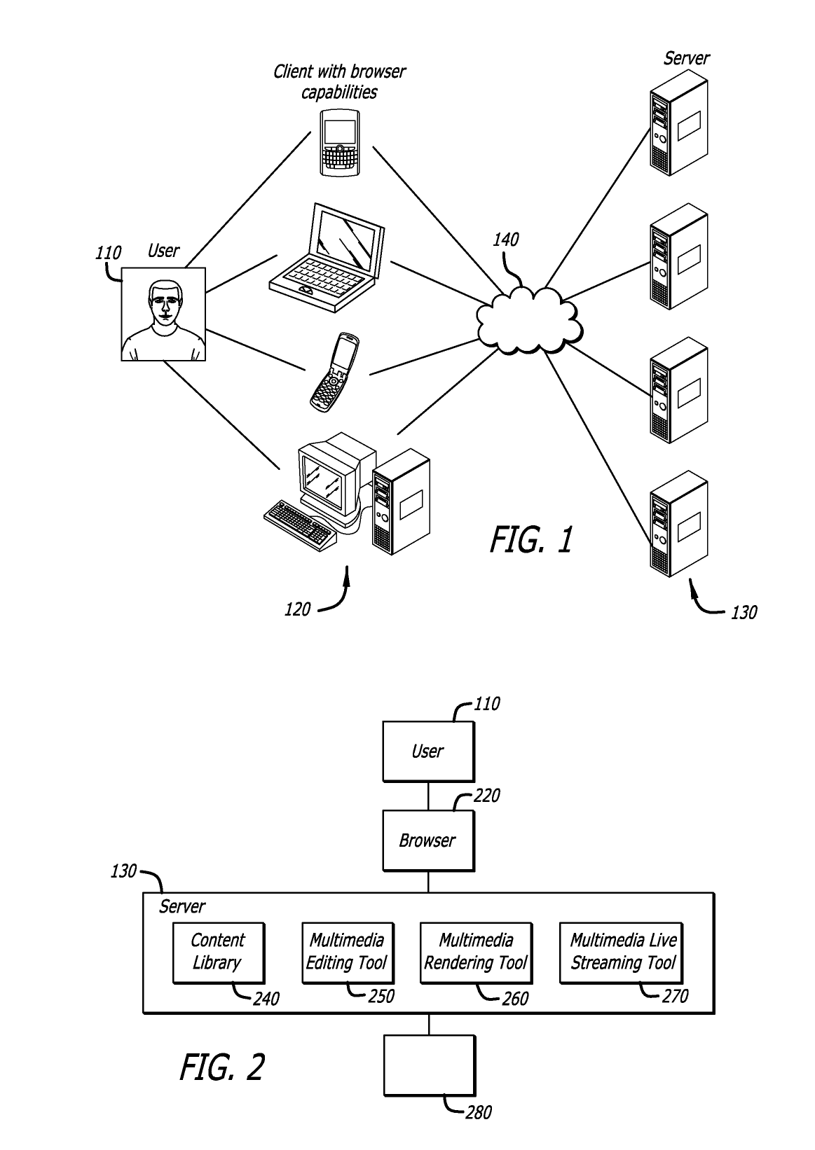

In brief overview, FIG. 1 is a diagram of a system for multimedia storing, editing and production. A user 110 accesses the media files through a client communication device 120 such as a computer, smartphone, cell phone, laptop, or any other client that is capable of running an internet browser and can interact via a network 140 with the server side of the system 130 which includes one or more servers configured to store, edit and produce multimedia productions.

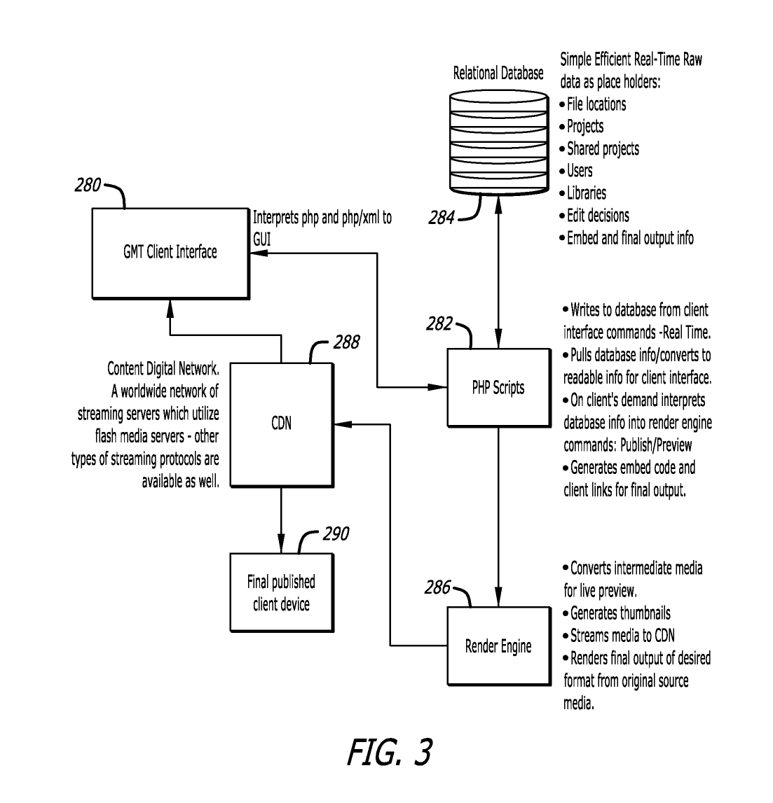

FIG. 2 is a block diagram for a system for multimedia storing, editing and production. A user 110 through a browser 220 can access one or more servers 130 which can contain a content library 240 for storing multimedia data files uploaded by a user and a plurality of tools including but not limited to an editing tool 250, a rendering tool 260 and a real time streaming tool 270. A user can then publish the edited multimedia data as a multimedia production over a network to an audience 280.

A content library 240 provides storage for multimedia data uploaded to the server containing the content library. Further description of the content library and its functionality are described herein. An editing tool 250 provides a user with a variety of multimedia editing functions. Further description of the editing tool and its functionality are described herein.

A rendering tool 260 enables a user to view multimedia content and data within the content library and to preview multimedia content that has been edited using the editing tool. The rendering tool can convert the multimedia data files and edited multimedia data files into a single format regardless of the format the multimedia data file was in when uploaded to the content library. In one embodiment, the rendering tool converts the multimedia data and/or edited multimedia data into a format that is matched to predetermined value settings for the user's desired multimedia format and device used for video playback.

To increase the quality of the displayed media, the rendering tool adjusts the playback settings for streaming media based on the user's desired multimedia format. A set of predetermined values specific to the user's desired multimedia format reduce the bandwidth required to stream media content and increase the quality of displayed media content irrespective of the content viewer's display device specifications and requirements. Predetermined values can include, without limitation, a custom frame size, a selected pixel aspect ratio, a selected frame-rate, a progressive order, a selected number of reference frames, a selected average variable bit rate, and a maximum variable bit rate. In part, the predetermined value settings of the exemplary systems and methods disclosed herein produce quality streaming displays at low variable bit rates, reducing bandwidth used for streaming. As such, the quality of the displayed media remains the same regardless of the viewer's display device.

A real time streaming tool 270 allows a user to publish his/her multimedia data and/or edited multimedia production for viewing. In one embodiment, the real time streaming tool is GIBBYSTREAMTM (Gibby Media, Spokane, Wash.).

In one embodiment, a user can access the system via a client through the use of a browser connected to a network. Via the network, the user's client can communicate with one or more of the servers that are part of the system. The user first encounters a webpage for logging on to the system, or to create a new account. Once the user has successfully logged on to the system, the user, using a storage device, uploads multimedia data to a content library located on one or more of the servers. The storage device allows the user to select the location of the multimedia data to be uploaded, to assign the multimedia data a name, description, keywords, and a license. In some embodiments, a Content Delivery Network (CDN) of edge servers can be utilized in conjunction with one or more the servers in order to copy the stored multimedia in a location physically closer to the user.

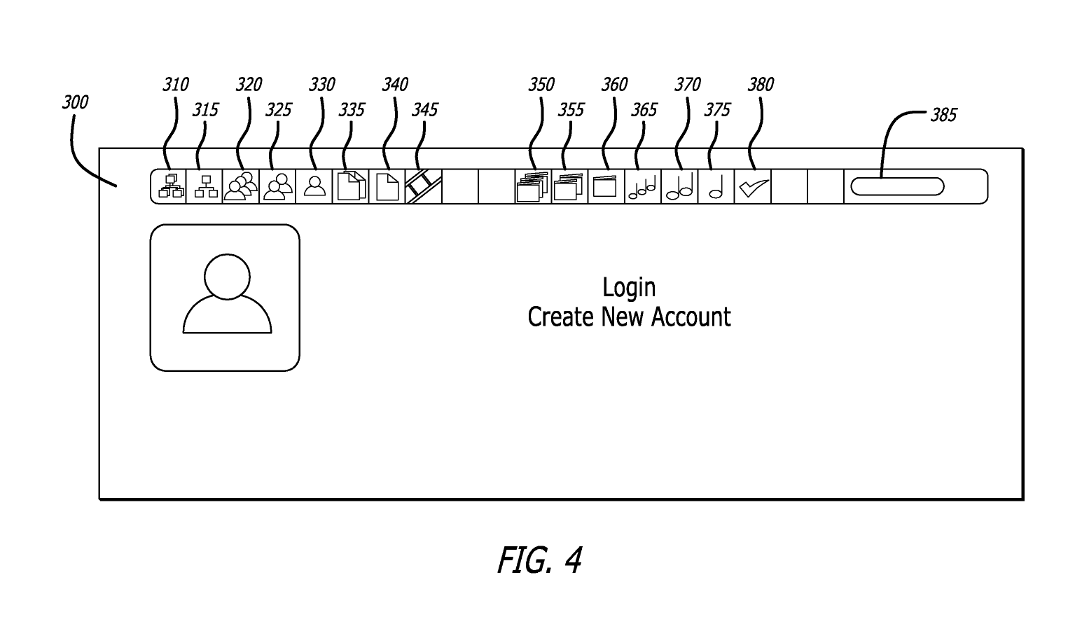

In brief overview, and referring to FIG. 3, the graphic user interface (GMT) 280 writes interface commands from a user to a scripting engine 282 which interprets those commands and writes data to or reads data from a relational database 284. The scripting engine 282 handles the user commands which produce edited content to a rendering engine 286 which renders the images for publishing. The rendering engine 286 converts intermediate media into final output for publishing on the Content Digital Network 288 for viewing by a client device 290.

Once multimedia data is uploaded to the content library, the user can access the editing tool and select the uploaded multimedia data for editing. Using the editing tool, the user can perform a number of actions relating to the editing of the multimedia data; a number of which are listed and discussed herein. Once the desired edits have been completed, the user, through the use of the rendering tool, selects a format for the multimedia production and has the rendering tool convert the edited multimedia production into the user's desired format. User selectable formats can include, but are not limited to, Moving Pictures Experts Group 4 (MPEG-4 or MP4), Audio Video Interleave File (AVI), Windows Media File (WMV), QuickTime Video Clip (MOV), 3rd Generation Multimedia File (3GP) and HyperText Markup Language (HTML) 5. User selectable audio file formats can include, but are not limited to, Ogg Vorbis Codec Compressed Multimedia File (OGG) and Ogg Vorbis Video Profile (OGV). Finally, the user then publishes the rendered multimedia production for viewing by an audience using the system's real time streaming tool. In some embodiments, a user can edit and/or revise a published multimedia production post publication and/or viewing by the audience using the various tools described herein.

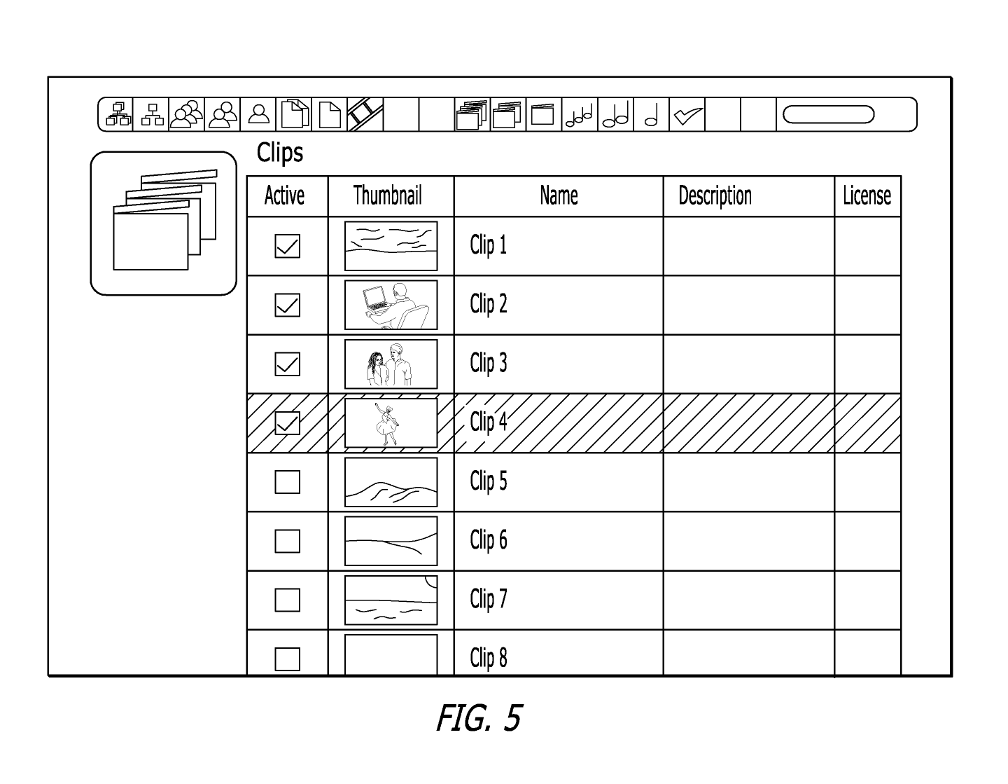

FIGS. 4-10 represent one embodiment of the disclosure described herein. Referring to FIG. 4, the navigation bar 300 contains a number of icons used to navigate within the system along with a keyword search function window 385. A first set of icons 310-330 provide a user with access to aspects of the system dealing with user account administrative functions. A second set of icons 335-340 provide a user with access to various tools relating to multimedia editing, rendering and production projects. A third set of icons 350-360 provide a user with access to the content library and storage functions. A fourth set of icons 365-375 provide a user with access to the content library and storage functions for audio data files. In more detail, the icon 345 provides a user with access to the system editing functions and the icon 380 provides a user with access to multimedia production related information including, without limitation, release notes regarding multimedia data files, audio data files and multimedia productions.

A user can access the administrative function icons to perform a number of tasks. The “Organizations” icon 310 provides a user with the information regarding all organizations for which the user is associated. The “Organization” icon 315 provides a user the information for what tier of service the organization is receiving. This includes, without limitation: storage amount, bandwidth amount, secure or un-secure HTTP communications, watermark, number of allowable sub-accounts, and price per month. The “Associates” icon 320 provides a user with a list of all sub-accounts for the organization. This list includes, without limitation, all users for the organization, and includes each user's name and email address. In addition, a user designated as an administrator can invite other users to join, building a network of users who can access the system within the user's organization. The “Team” icon 325 provides a user with a list of all users that are established and associated together as a team. Teams can be created to work together on specific projects and edits allowing for collaborative editing of multimedia productions. Finally, the “User” icon 330 provides a user with information regarding his/her system account, including without limitation, login information, session information, and associated organizations, associates and teams.

A user can access the various tools related to multimedia editing, rendering and production projects. The “All Projects” icon 335 provides a list of all projects that have been created by the user. By selecting this icon, a user can create new projects. A user can provide the project with a name and description. This icon will also show who the manager of the project is, as well as if the project is private or public. A user can elect to share one or more projects with one or more additional users. Users who have been elected as a sharee by the sharor can access the projects of the sharor and using the various tools described herein can edit, render and produce multimedia separate from or in collaboration with the sharor and other sharor selected sharees. In some embodiments, simultaneous collaborative work can occur between the user/sharor and the user selected sharees of the project. It is important to realize that multiple users may work on the same project sequentially by locking access to each clip as it is used and each track as it is edited until the present editor user releases the file.

By selecting or deselecting projects on the All Projects page a user can determine which projects will be shown on the Active Projects page. The “Active Projects” icon 340 provides a list all the projects the user is currently working on. In addition selecting the icon will show the names of all the active projects, list the active project's manager, and shows if the project is private or public. Also, any project that is currently in the edit window is shown in bold.

A user can access a variety of interfaces that provide multimedia editing functions. The “Editor” icon 345 provides an interface for editing multimedia data. The user can perform one or more editing actions, including without limitation, previewing the multimedia data, cropping or trimming the multimedia data, inserting one or more multimedia data files, overlaying one or more multimedia data files, removing a portion or portions of the multimedia data, provide transitioning between one or more multimedia data files, inserting images, text and audio within a multimedia data file, previewing the edited multimedia data. From the “Editor” icon 345, a user can also render and publish multimedia data, giving the user a simple embed code, all from the “Editor”.

A user can access the system's content library and access the system's storage functions. The “Clip Library” icon 350 provides a user access to all clips that the user's associated organization has uploaded to the content library. Multimedia data files or clips can be represented by a thumbnail image. The Clip Library also provides additional information regarding the multimedia data within the content library including, without limitation, the user applied name for the clips, the description or the clip's content, and whether the clip is private or public (private clips can only be used by users from their respective organization, whereas public clips can be used by any user from any organization using the system). The “Clip Library” icon 350 also provides a user with an interface for the uploading of multimedia data to the content library. The “Active Clips” icon 355 provides a user with a list of clips that are associated with the user's current Active Project. The clips appearing within the Active Clips section can be viewed by a user upon accessing the system's editor function. In addition, clips listed within the Active Clips section are all the clips that are selected from the Clip Library that were previously loaded to the content library by a user. Any clips that are deselected from the Clip Library will remain there, but will not appear within the Active Clips section. The “Clip” icon 360 provides a user with an interface to upload multimedia data. The interface allows a user to perform a number of actions including, without limitation, to browse for the multimedia data file on the user's client communication device, assign a name, description and search-able keywords to the multimedia data file and assign the multimedia data file a private or public license. The uploaded multimedia data file can be converted, if necessary, and stored within the content library.

Much like the Clip icons discussed above, the system allows a user to access the content library and storage functions specifically for audio data files. The “Audio Library” icon 365 provides a user with an interface to upload audio data files to the content library. Audio data files can be selected by a user to use within any multimedia editing project. The “Active Audio” icon 370 provides a user with a list of all audio data files that are assigned to the user's current Active Project. The “Audio Clip” icon 375 provides a user an interface to upload audio data. The interface allows a user to perform a number of actions including, without limitation, to browse for the audio data file on the user's client communication device, assign a name, description and searchable keywords to the audio data file and assign the audio data file a private or public license. The uploaded audio data file will be converted, if necessary, and stored within the content library.

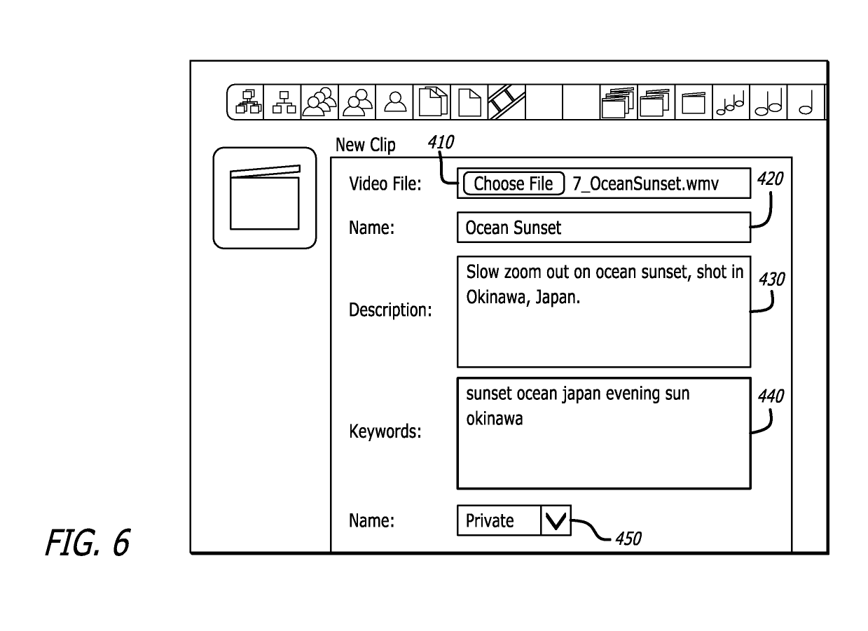

FIG. 5 is a screen shot of an example user webpage displaying the content library. A user visiting the system and selecting 350 (FIG. 4) would be directed to a webpage resembling FIG. 5. As shown, the content library of FIG. 5 contains multiple multimedia data files represented by thumbnail pictures and listed user input data regarding the name, description and license details for each listed multimedia data file within the content library. Also displayed is a selection box through which a user can select a multimedia data file as “Active.” Selecting a multimedia data file as Active will list the multimedia data file within the user's active clips discussed previously in FIG. 4.

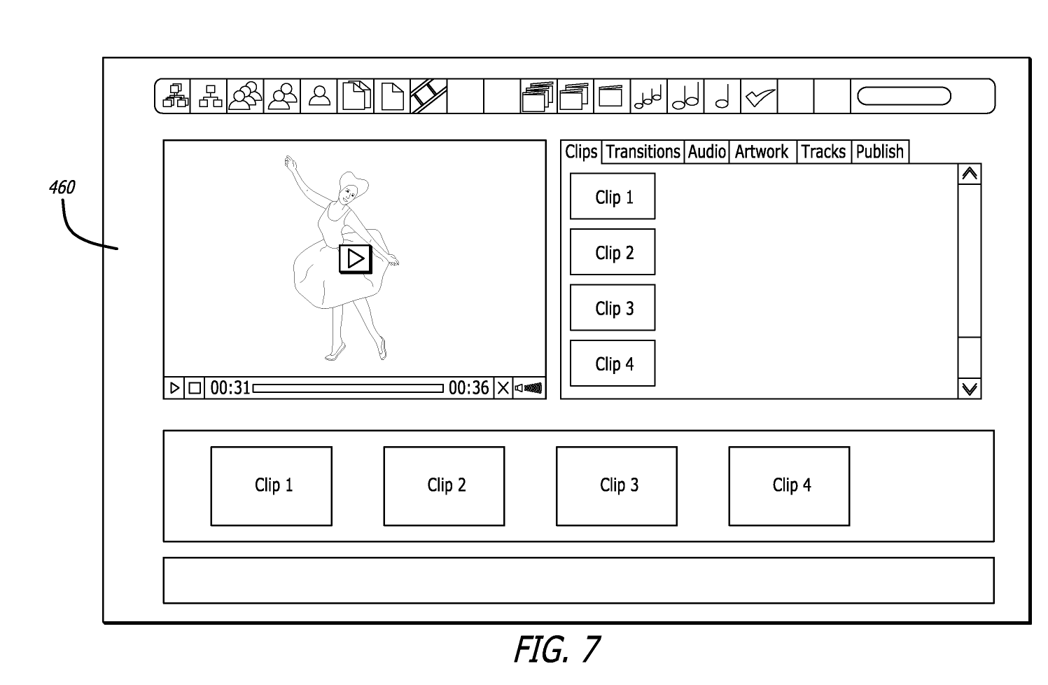

FIG. 6 is a screen shot of an example user webpage displaying the interface that allows a user to upload multimedia data to one of a plurality of storage devices. With the interface, the user can perform a plurality of tasks including, without limitation, selecting the file user wishes to upload to the content library by clicking on the “Choose File” button 410; assign a name to the multimedia data 420; provide a description of the multimedia data to assist in the organization of the content library 430; provide one or more keywords relating to the multimedia data to help provide keyword search functionality to the content library 440; and determine third party access to the multimedia data by assigning a public or private license value 450.

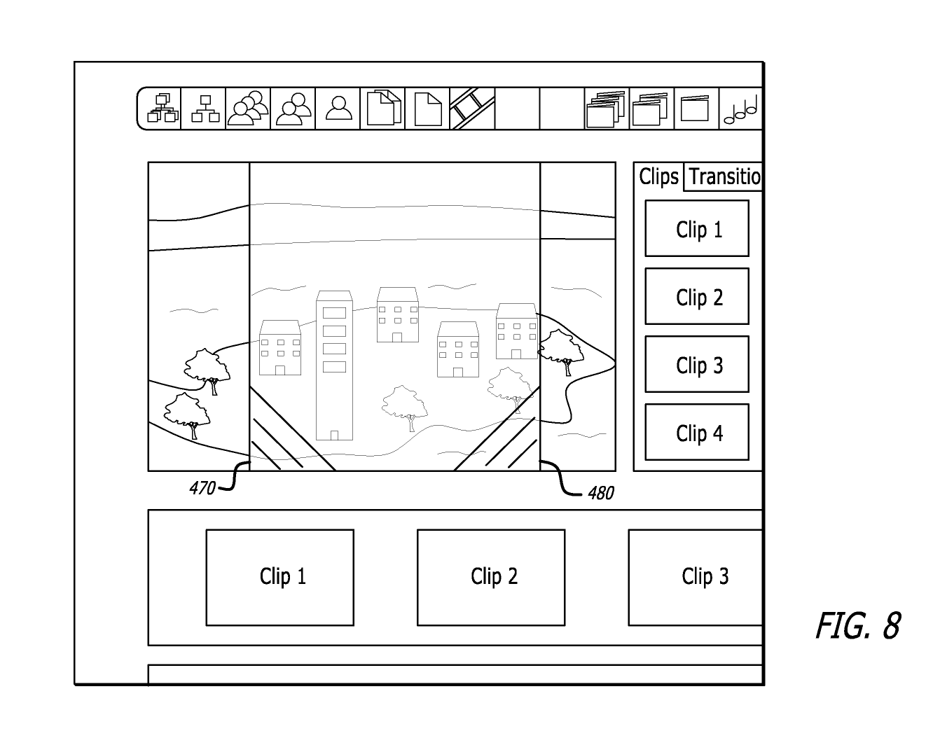

FIG. 7 is a screen shot of an example user webpage displaying the system's editing tool. The user's “Active Project” is displayed as a sequence of multimedia data files represented by thumbnail images. The rendering tool 460 provides the user with a preview of the edited multimedia production.

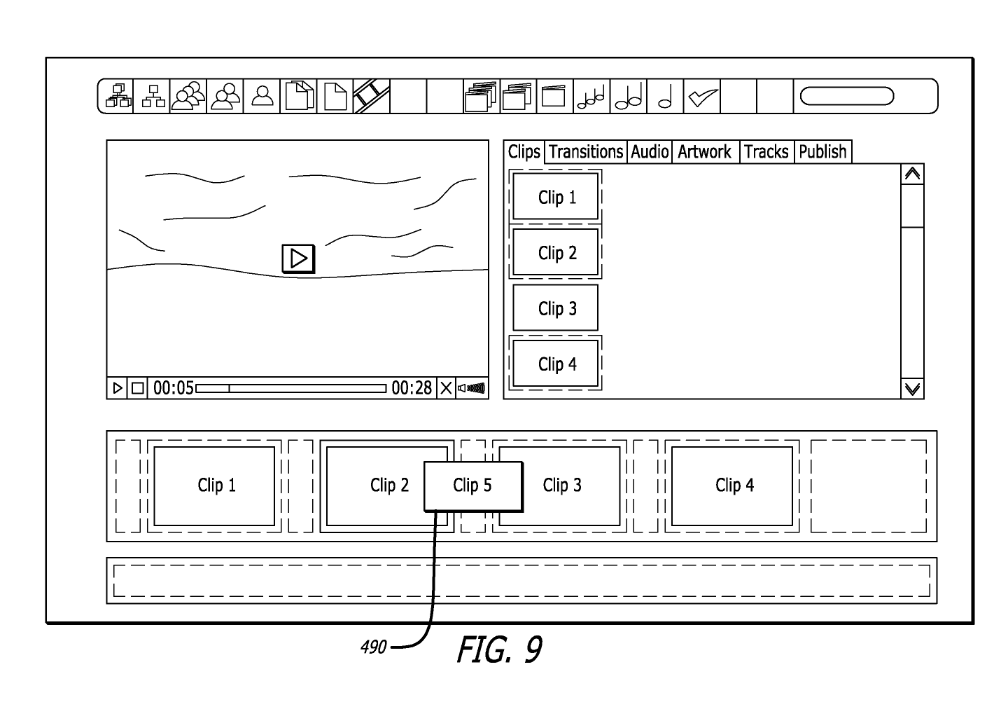

FIG. 8 is a screen shot of an example user webpage displaying the system's editing tool performing a crop of the selected multimedia data. The viewable area of the multimedia data as shown is being reduced by using the size selection tabs 470 and 480

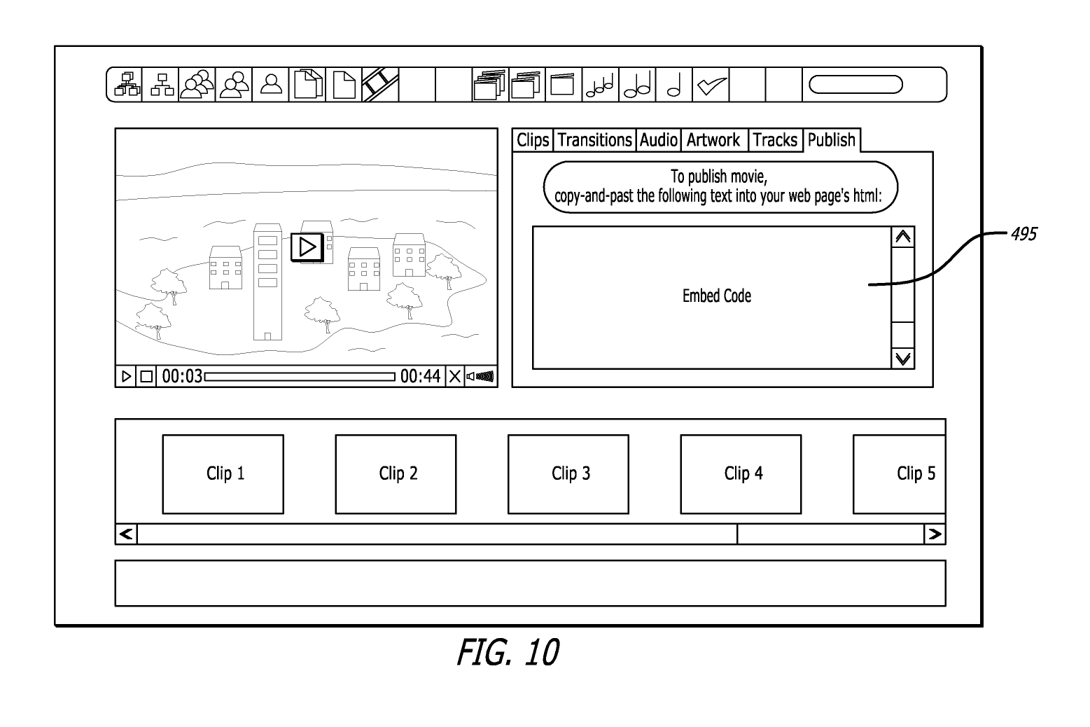

FIG. 9 is a screen shot of an example user webpage displaying the system's editing tool performing a combination of multiple multimedia data files. As shown, four multimedia data files from the content library files have been combined and a fifth multimedia data file 490 is being inserted between the second and third multimedia data files.

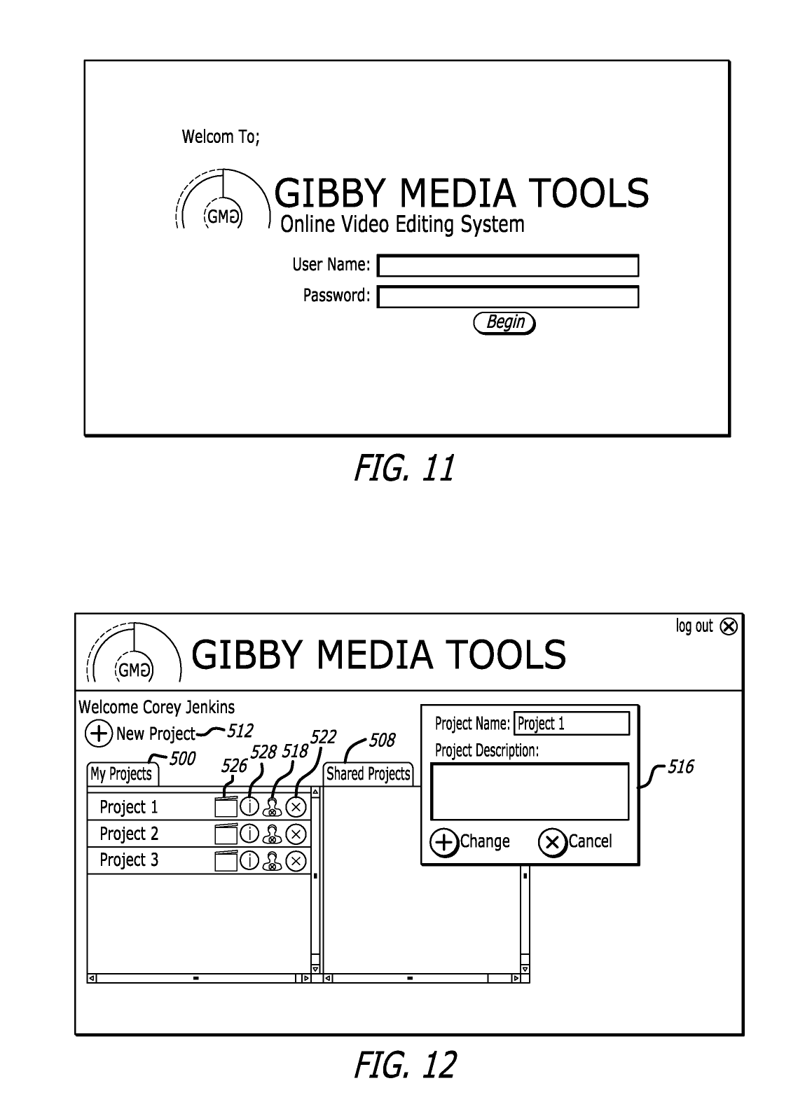

FIG. 10 is a screen shot of an example user webpage displaying the system's rendering tool. As shown the rendering tool is displaying a multimedia production created through the combination of multiple multimedia data files. Also displayed is the embed code 495 that a user can use to link others to the multimedia production.

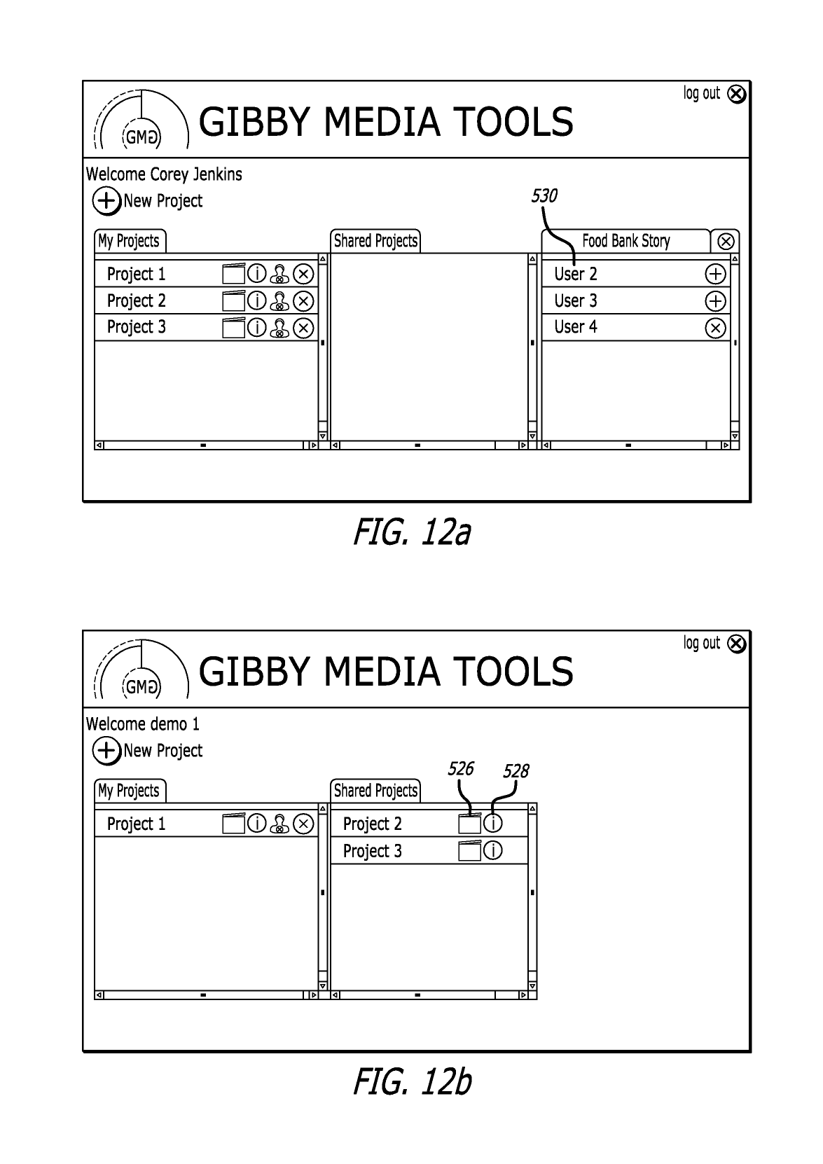

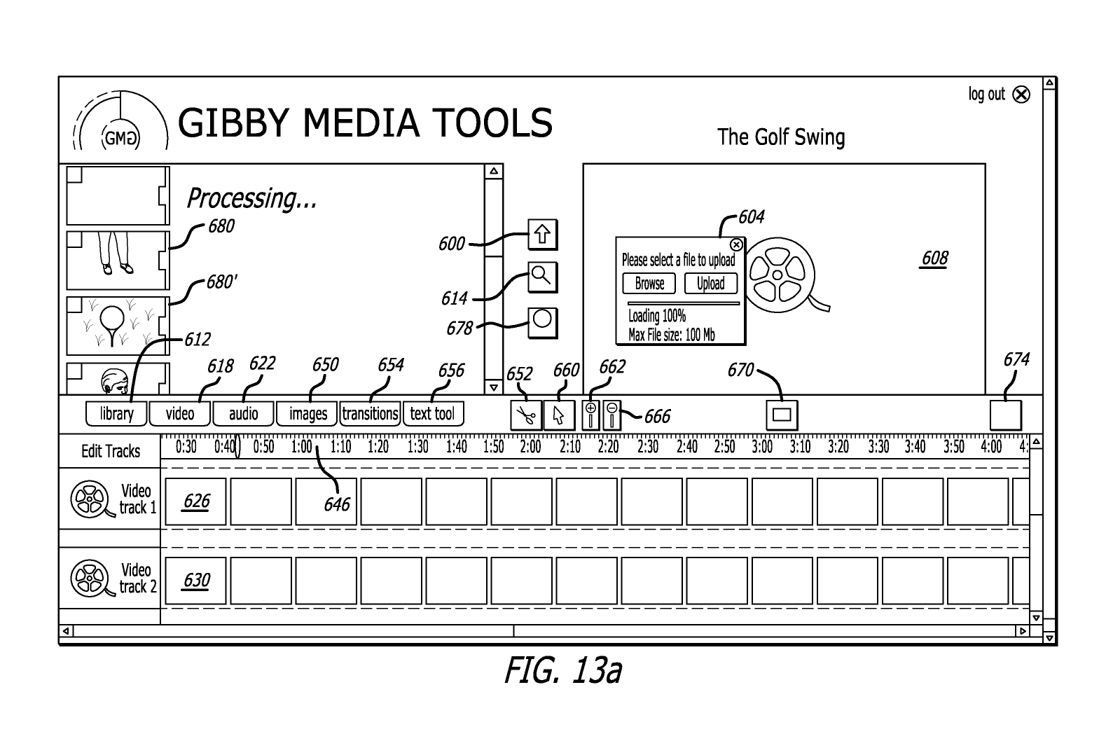

FIGS. 11-14 represent another embodiment of the disclosure described herein. FIG. 11 is a screen shot of the login webpage, similar to most login pages, a user typically sees when visiting the system. Once authenticated by the system, the user moves to a page (FIG. 12) which lists the user's projects 500 and those projects shared with other users 508, and allows the user to designate new projects 512 through a pop-up window 516. Using the icons associated with each project, the user can add another user 518 to the project to create a shared project, delete a project 522 or edit a project 526. A user's selection of the project deletion icon 522 removes the selected project from the user's project; however, the project remains stored within the storage devices. FIG. 12a is a screen shot of the screen of a user when the add user icon is selected, and three new users 530 given permission to work on the project.

FIG. 12b shows the screen of a user after multiple users have been added to each project. The shared projects window 508 shows the shared project list and the icons to edit the project or obtain information about the project 528.

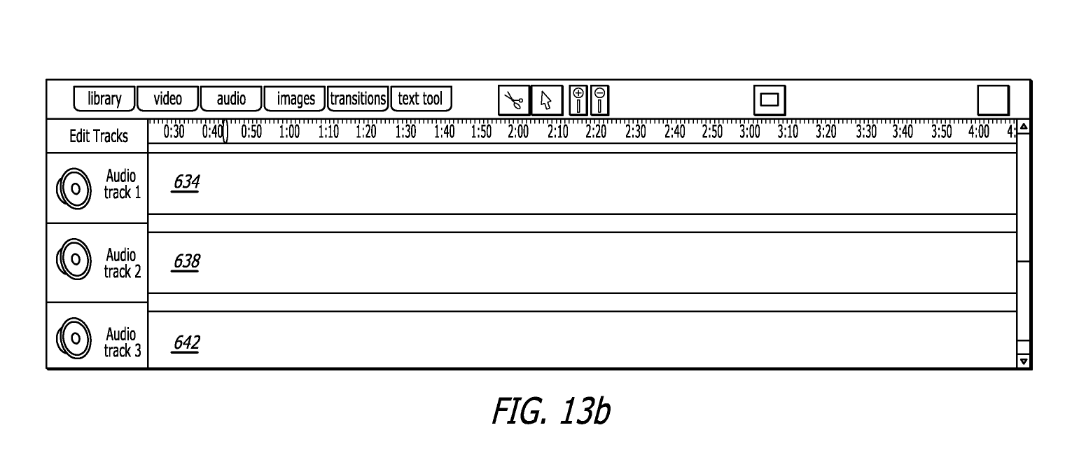

FIGS. 13a and 13b shows an embodiment of an editing screen the invention which appears when the edit icon 526 is selected. In this embodiment in FIG. 13a the buttons allow the user to upload a file by using a button 600 to cause a pop-up screen 604 to appear in a preview area 608. The user can choose to load from a library by using button 612 and search that library by using search button 614.

Buttons allow for the video 618 or audio 622 portions of the file to be edited. If the video portion is selected the tracks 626 and 630 for editing are shown. If the audio 622 portion is selected for editing tracks 634, 638, and 642 are instead shown as in FIG. 13b. The number of audio or video tracks is not limited to two video and three audio.

An edit page a time line 646 is shown above the tracks to orient the user within the content. The user can also select individual images with the image button 650, control the transition (for example fadeout) between images using the transition button 654 and open a text editor using the text tool button 656 allowing the user to create and add text to the project. In addition the user can cut an image 652, zoom in 662, zoom out 666, and preview 670 the content in the preview area 608 again by using the designated buttons. The user can also non-destructively remove tracks using the trash button 674. The user can select any of the icons, images, videos or other selectable content using the cursor tool 660. When all is complete the user can publish the content using the publish button 678.

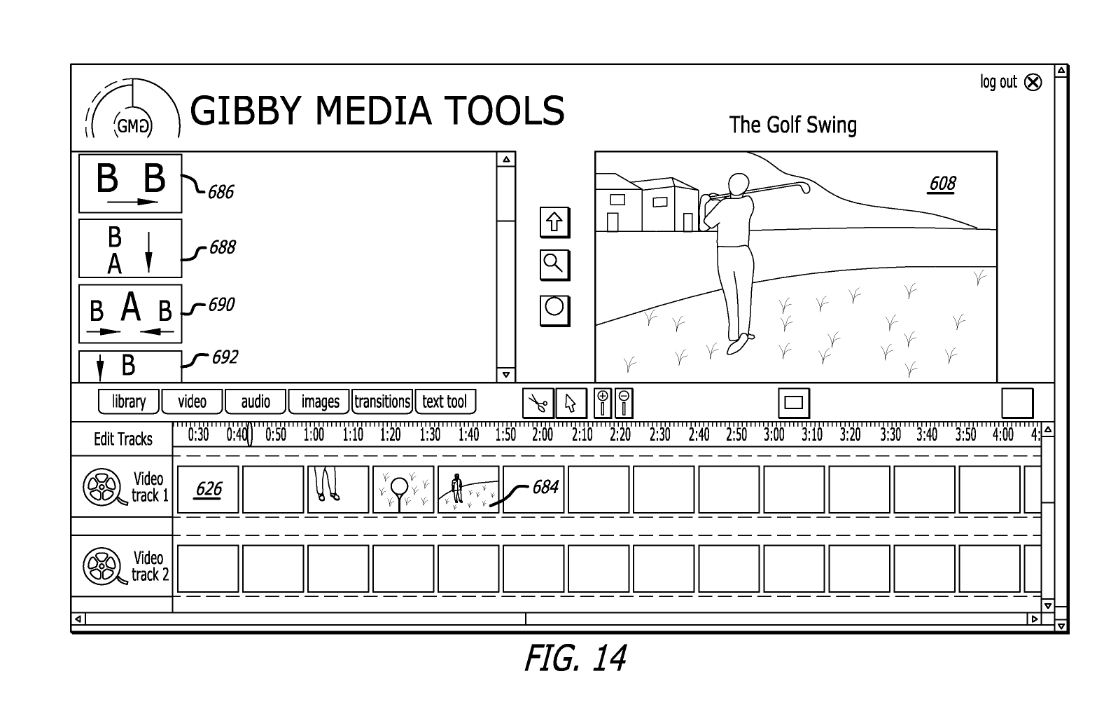

Referring again to FIG. 13a, the user is in the process of loading a series of files or clips (680, 680′, generally 680) with which he or she will form video content. Referring to FIG. 14, the user has taken the clips 680 and placed them on the video track 626 in the position in the sequence he or she wishes. Each clip is movable separately and the transitions between the clips may be controlled by the user. Some of the transitions available to the user include, without limitation, pan right overlay 686, pan down overlay 688, horizontal center merge overlay 690 and vertical center merge overlay 692. The next clip to be included is located in the preview area 608 and the user can insert this clip of the actual golf swing after clip 684.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods disclosed herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are disclosed herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically disclosed herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or and consisting essentially of language. When used in the claims, whether as filed or added per amendment, the transition term “consisting of excludes any element, step, or ingredient not specified in the claims. The transition term “consisting essentially of limits the scope of a claim to the specified materials or steps and those that do not materially affect the basic and novel characteristic(s). Embodiments of the invention so claimed are inherently or expressly described and enabled herein.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A system for storing, editing and producing multimedia productions comprising:
a server comprising:
a storage device for storing multimedia data as a content library; and
a plurality of tools, comprising:
a multimedia editing tool allowing a user to edit the stored multimedia data using a browser running on a client;
a rendering tool allowing a user to create a viewable multimedia production from the edited multimedia data using the browser running on the client; and
a real time streaming tool for distributing the viewable multimedia production.

2. The system of claim 1 wherein the server is one of a plurality of servers each of which is in communication with the storage device.

3. The system of claim 2 wherein at least one of the plurality of servers utilizes a content delivery network of edge servers to copy the content library to a server located physically closer to the user.

4. The system of claim 1 wherein the storage device is one of a plurality of storage devices each of which is in communication with the server.

5. The system of claim 1 wherein thumbnail pictures of the multimedia data are provided to represent multimedia data stored within the content library.

6. The system of claim 1 further comprising a means for searching the content library.

7. The system of claim 1 wherein the multimedia data comprises a plurality of clips and wherein the multimedia editing tool is configured to allow at least one editing action selected from: combining one or more clips, cropping one or more clips, inserting one or more clips, overlaying one or more clips, removing a portion of one or more clips, adding a transitional effect to one or more clips, inserting text in one or more clips, and inserting sound in one or more clips.

8. The system of claim 1 wherein the multimedia editing tool is configured to allow two or more users to collaboratively edit the stored multimedia data.

9. The system of claim 1 wherein the rendering tool converts the edited multimedia into a format selected by the user, wherein a set of predetermined values are used during the conversion based upon the user selected format.

10. A method for providing multimedia storing, editing and production capabilities to a user on a client comprising:
uploading and storing multimedia data on a content library by users, wherein the content library comprises a server and tools in communication with the client;
editing multimedia data stored within the content library by users;
rendering the edited multimedia data into a viewable multimedia production; and
providing real time streaming of the viewable multimedia production via a network.

11. The method of claim 10 wherein the server is one of a plurality of servers each of which is in communication with the client.

12. The method of claim 11 wherein at least one of the plurality of servers utilizes a content delivery network of edge servers to copy the content library to a server located physically closer to the user.

13. The method of claim 10 wherein the multimedia data comprises a plurality of clips and wherein the step of editing comprises at least one action selected from:
combining one or more clips, cropping one or more clips, inserting one or more clips, overlaying one or more clips, removing a portion of one or more clips, adding a transitional effect to one or more clips, inserting text in one or more clips, and inserting sound in one or more clips.

14. The method of claim 10 further comprising the step of searching the content library.

15. The method of claim 10 wherein the editing of multimedia data stored within the content library can be conducted collaboratively by two or more users.

16. The method of claim 10 wherein the viewable multimedia production when rendered is converted into a format selected by the user, wherein a set of predetermined values are used during the conversion based upon the user selected format.
